(19) United States
(12) Patent Application Publication
(10) Pub. No.: US 2023/0267377 A1
(43) Pub. Date: Aug. 24, 2023

(54) APPLIED MACHINE LEARNING PROTOTYPES FOR HYBRID CLOUD DATA PLATFORM AND APPROACHES TO DEVELOPING, PERSONALIZING, AND IMPLEMENTING THE SAME

(71) Applicant: Cloudera, Inc., Santa Clara, CA (US)

(72) Inventors: Sushil Thomas, San Francisco, CA (US); Jeanne Schaser, Pacifica, CA (US); Andrew Reed, Baltimore, MD (US); Melanie Beck, Minneapolis, MN (US); Alex Bleakley, South Jordan, UT (US); Yuya Yabe, Santa Clara, CA (US); Yi Hsun Tsai, San Francisco, CA (US); Patrick David Hunt, Palo Alto, CA (US); Subhadeep Sinha, Fremont, CA (US); Victor Chukwuma Dibia, Santa Clara, CA (US); Christopher James Wallace, Whitley Bay (GB); Jeffrey George Fletcher, Berlicum (NL); Ofek Gila, Cupertino, CA (US)

(21) Appl. No.: 18/174,497

(22) Filed: Feb. 24, 2023

Related U.S. Application Data
(60) Provisional application No. 63/313,611, filed on Feb. 24, 2022.

(51) Int. Cl. G06N 20/00

(52) U.S. Cl. CPC G06N 20/00

(57) ABSTRACT

Development of machine learning models and applications tends to be iterative and complex, made even harder because most of the necessary tools are not built for the entire machine learning lifecycle. Introduced here is a data platform that is able to accelerate time-to-value by enabling users to utilize applied machine learning prototypes (“AMPs”) made by others. These AMPs may be extendable, by the data platform, to new datasets, allowing machine learning to be developed and deployed more rapidly.

### CROSS-REFERENCE TO RELATED APPLICATIONS

This application claims priority to U.S. Provisional Application No. 63/313,611, titled “Applied Machine Learning Prototypes (AMPs) for Hybrid Cloud Data Platform” and filed Feb. 24, 2022, which is incorporated by reference herein in its entirety.

### TECHNICAL FIELD

Various embodiments concern computer programs and associated computer-implemented techniques for developing and implementing algorithms to facilitate the application of machine learning.

### BACKGROUND

Machine learning is the study of computer algorithms (or simply “algorithms”) that can improve automatically through experience with the use of data. These algorithms generally build a machine learning model (or simply “model”) based on sample data—also called “training data”—in order to make predictions without being explicitly programmed to do so. These algorithms are used in a wide variety of applications, and the number of possible applications continues to expand.

A core objective of machine learning is to generalize from experience. Generalization in this context is the ability of a model to perform accurately on new examples after having learned through analysis of old examples included in training data. In order to improve performance, the old examples included in the training data generally come from some probability distribution that is considered representative of the possible occurrences. Ensuring that the old examples cover a large enough gamut of the possible occurrences is an important aspect of training, as it ensures that the model is sufficiently “flexible” to accept new examples that are different than the old examples.

In theory, introducing machine learning to address a new problem or situation is a rather straightforward concept. However, appropriately designing, training, and then implementing models (and more generally, machine learning applications that make use of models) tends to be difficult in practice.

### BRIEF DESCRIPTION OF THE DRAWINGS

FIG. 1 illustrates a network environment that includes a data platform that is executed by a computing device.

FIG. 2 illustrates an end-to-end workflow that involves machine learning.

FIG. 3 includes an example of such an interface through which applied machine learning prototypes (“AMPs”) can be selected and installed.

FIG. 4 shows examples of machine learning challenges for which AMPs can be developed.

FIG. 5A illustrates how a catalog of AMPs can be formed.

FIG. 5B illustrate how AMPs can be launched from a workspace.

FIG. 6 illustrates how a secondary panel may be shown in response to a user selecting an “AMP tile” to indicate that she is interested in utilizing the corresponding AMP to create a project.

FIG. 7 illustrates how a user can configure a project by altering parameters of an AMP through an interface.

FIG. 8 illustrates how progression of a data platform as it completes the necessary steps to create a project based on an AMP may be shown in an interface.

FIG. 9 shows an interface that may be presented after construction of the project is complete.

FIGS. 10A-J include a series of interfaces that illustrate how a user can instantiate an AMP as a project.

FIG. 11 includes an interface that shows how catalogs may be pointed to within the context of the data platform.

FIG. 12 includes a flow diagram of a process for creating an AMP based on an existing data science project.

FIG. 13 includes a flow diagram of a process for implementing an AMP as part of a new data science project.

FIG. 14 includes a flow diagram of a process for creating a collection of AMPs, each of which corresponds to a different data science project that utilizes machine learning to address a problem and/or perform a task.

FIG. 15 is a block diagram illustrating an example of a processing system in which at least some of the operations described herein can be implemented.

Various features of the technology described herein will become more apparent to those skilled in the art from a study of the Detailed Description in conjunction with the drawings. While certain embodiments are depicted in the drawings for the purpose of illustration, those skilled in the art will recognize that alternative embodiments may be employed without departing from the principles of the technology. The technology is amenable to various modifications.

### DETAILED DESCRIPTION

Machine learning has become one of the most critical capabilities for modern businesses to grow and stay competitive today. From automating internal processes to optimizing the designing, creating, and marketing processes behind many products, machine learning models (“ML models” or simply “models”) and machine learning applications (“ML applications” or simply “applications”) have permeated nearly every aspect of our work and personal lives.

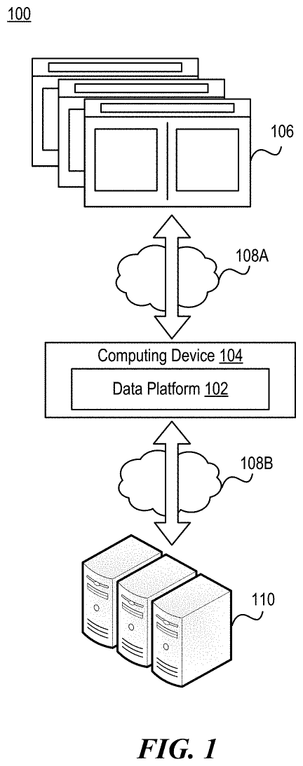

Development of ML models and applications tends to be iterative and complex, made even harder because most of the necessary tools are not built for the entire machine learning lifecycle. FIG. 1 includes a high-level illustration of a data platform that is able to accelerate time-to-value by enabling users to collaborate in a single place that is all inclusive for powering different artificial intelligence use cases. The users could be software programmers or data scientists, for example. The data platform may be purpose built for agile development, experimentation, or production of workflows involving ML models and applications. Solving critical challenges along the entire machine learning lifecycle with greater speed and agility can allow for the discovery of opportunities that can mean the difference for users.

FIG. 1 illustrates a network environment 100 that includes a data platform 102 that is executed by a computing device 104. Generally, the computing device 104 is a computer server that is part of a server system 110 accessible via the Internet. However, the computing device 104 could be a personal computing device, such as a mobile phone, tablet computer, or desktop computer, that is accessible to the server system 110 as further discussed below. Users may be able to interface with the data platform 102 via interfaces 106 that are accessible via respective computing devices. For example, a user may be able to access an interface through a web browser that is executing on a laptop computer or desktop computer. Similarly, users may be able to access the interfaces 106 through computer programs such as mobile applications and desktop applications.

As shown in FIG. 1, the data platform 102 may reside in a network environment 100. Thus, the computing device 104 on which the data platform 102 resides may be connected to one or more networks 108A-B. These networks 108A-B may be personal area networks (“PANs”), local area networks (“LANs”), wide area networks (“WANs”), metropolitan area networks (“MANs”), cellular networks, or the Internet.

The interfaces 106 may be accessible via a web browser, desktop application, mobile application, or another form of computer program. For example, in embodiments where the data platform 102 resides on a computer server (e.g., that is part of a server system 110), a user may interact with the data platform 102 through interfaces displayed on a desktop computer by a web browser. As another example, in embodiments where the data platform 102 resides—at least partially—on a personal computing device (e.g., a mobile phone, tablet computer, or laptop computer), a user may interact with the data platform 102 through interfaces displayed by a mobile application or desktop application. However, these computer programs may be representative of thin clients if most of the processing is performed external to the personal computing device (e.g., on a server system 110).

Generally, the data platform 102 is either executed by a cloud computing infrastructure operated by, for example, Amazon Web Services, Google Cloud Platform, Microsoft Azure, or another provider, or provided as software that can run on dedicated hardware nodes in a data center. For example, the data platform 102 may reside on a server system 110 that comprises one or more computer servers. These computer servers can include different types of data (e.g., associated with different users), algorithms for processing the data, trained and untrained models, and other assets. Those skilled in the art will recognize that this information could also be distributed among the server system 110 and one or more personal computing devices. For example, a model may be downloaded from the server system 110 to a personal computing device, such that the model can be trained or implemented on data that resides on the personal computing device. This “localized training” may be helpful in scenarios where privacy is important, as it not only limits the likelihood of unauthorized access (e.g., because the sensitive data is not transmitted external to the personal computing device) but also limits who has access to predictions output by the model.

As further discussed below, one aspect of the data platform 102 is its ability to support machine learning workspaces (or simply “workspaces”) in which users can develop, test, train, and ultimately deploy models for building predictive applications. An application may allow use of any data under management within the “data cloud” of the corresponding user. The data cloud (also called the “data lake”) could include data stored on public cloud infrastructure, private cloud infrastructure, or both. Accordingly, the data cloud could include data that is stored on, or accessible to, the server system 110 as well as any number of personal computing devices.

Note that the workspaces may be independently accessible and manipulable by the corresponding users. For example, the data platform 102 may support a first workspace that is accessible to a first set of one or more users and a second workspace that is accessible to a second set of one or more users, and any work within the first workspace may be entirely independent of work in the second workspace. Generally, the first and second sets of users are entirely distinct. For example, these users may be part of different companies. However, the first and second sets of users could overlap in some embodiments. For example, a company could assign a first set of data scientists to the first workspace and a second set of data scientists to the second workspace, and at least one data scientist could be included in the first set and second set. Similarly, a single user may instantiate or access multiple workspaces. These workspaces may be associated with different projects, for example.

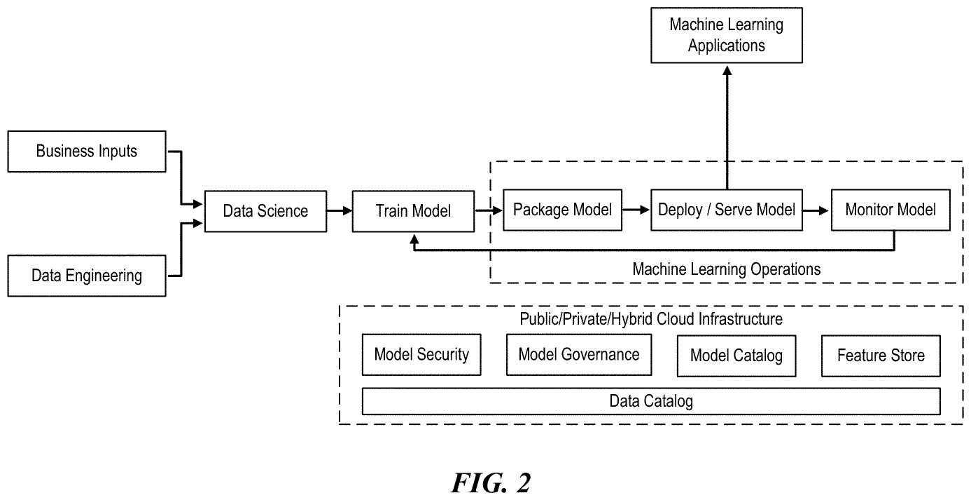

FIG. 2 illustrates an end-to-end workflow that involves machine learning. A data platform (e.g., data platform 102 of FIG. 1) can be designed to cover the entire workflow, enabling fully isolated and containerized workloads for data engineering and machine learning with seamless distributed dependency management. Embodiments of the data platform may have a number of core capabilities, including:
Sessions: Enable users to directly leverage the computing resources available across the workspace, while also being directly connected to the data in the data cloud.
Experiments: Enable users to run multiple variations of model training workloads, tracking the results of each experiment in order to identify the best model (e.g., in terms of metrics such as accuracy, resource consumption, time efficiency, or combinations thereof).
Models: Embodiments of the data platform may allow models to be deployed in a matter of clicks, removing roadblocks to production. For example, models may be served as representational state transfer (“REST”) endpoints in a high availability manner, with automated lineage building and metric tracking (e.g., for machine learning model operationalization and management purposes).
Jobs: Embodiments of the data platform may be used to orchestrate an entire end-to-end automated pipeline, including monitoring for model drift and automatically initiating re-training and re-deploying as needed. For example, the data platform may establish one or more criteria for when to initiate re-training (e.g., when accuracy drops below a threshold). These criteria may be automatically determined or derived by the data platform, or these criteria may be specified by a user through an interface that is generated by the data platform.
Applications: Embodiments of the data platform may deliver or enable interactive experiences for users in a matter of clicks. Frameworks (e.g., the Flask web framework or Shiny web framework) can be used in the development of applications, and a point-and-click interface may be available for developing these applications. Such an approach to application development lowers barriers to entry, as users (e.g., data scientists) without meaningful programming knowledge may be able to construct applications without issue.

### Introduction to Applied Machine Learning Prototypes

To improve the ease with which new applications can be developed, a data platform (e.g., data platform 102 of FIG. 1) may allow for the development and deployment of applied machine learning prototypes (“AMPs”). At a high level, AMPs are data science projects that rely on machine learning—for example, utilize a model trained to perform a task—and can be fully developed and deployed through the data platform. For example, an AMP could be implemented by the data platform to address a new problem with a single click that indicates how to implement the AMP. Simply put, an AMP can provide an end-to-end framework for building, deploying, and monitoring applications in near real time.

AMPs can provide reference machine learning projects that serve as examples indicating how the corresponding models can be extended to new problems, new users, and new data. More than simplified quick starts or tutorials, AMPs represent fully developed solutions to common problems in machine learning. These solutions demonstrate how to fully use the power of the data platform. Simply put, AMPs illustrate how users can utilize the data platform to solve their own use cases through the use of machine learning, without needing to have an in-depth knowledge of machine learning. For the purpose of illustration, AMPs may be described in the context of specific problems in machine learning. However, those skilled in the art will recognize that AMPs could be developed for various problems.

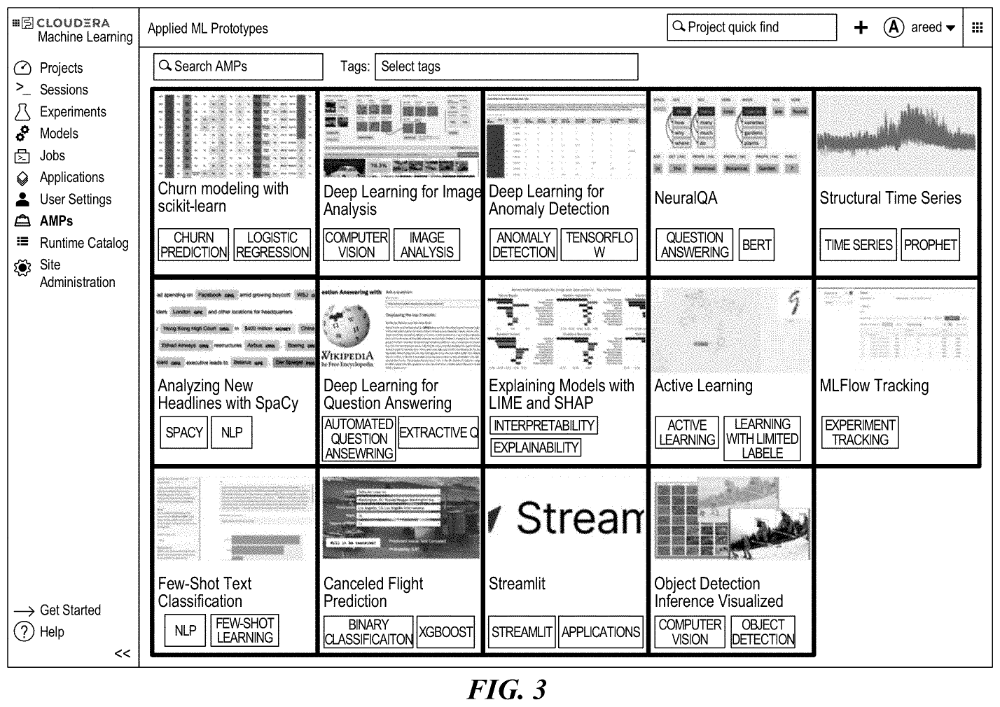

AMPs may be available to install and run from a user interface (or simply “interface”) that is generated by the data platform. FIG. 3 includes an example of such an interface. In the interface shown in FIG. 3, the AMPs that are available to the user are shown in one panel. As new AMPs are developed, those new AMPs may be populated into the panel (and therefore, become available for use).

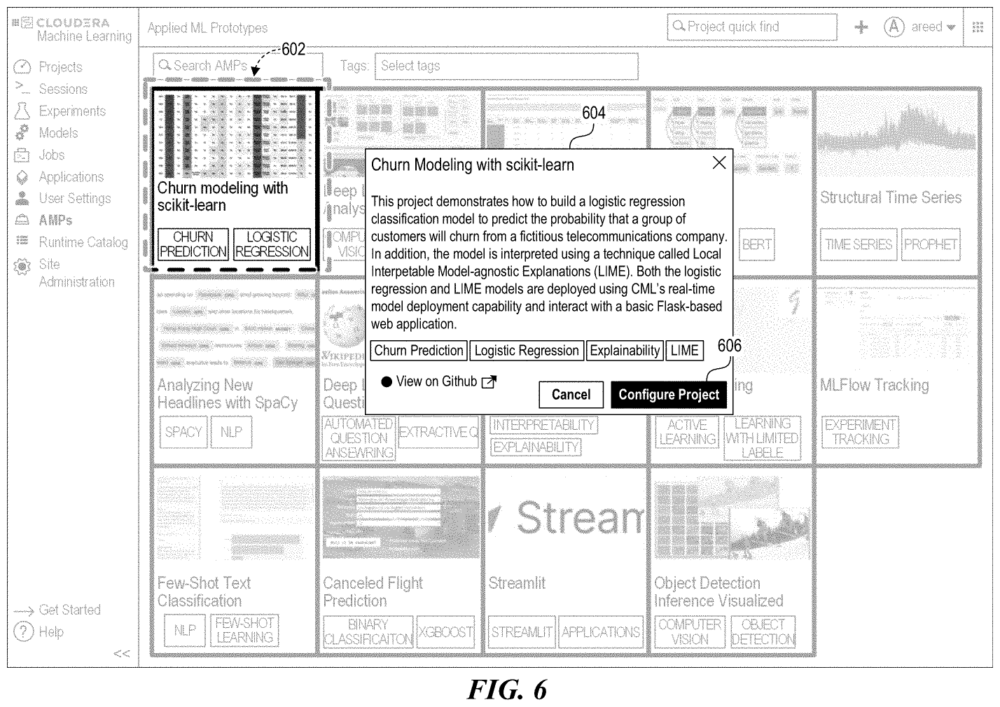

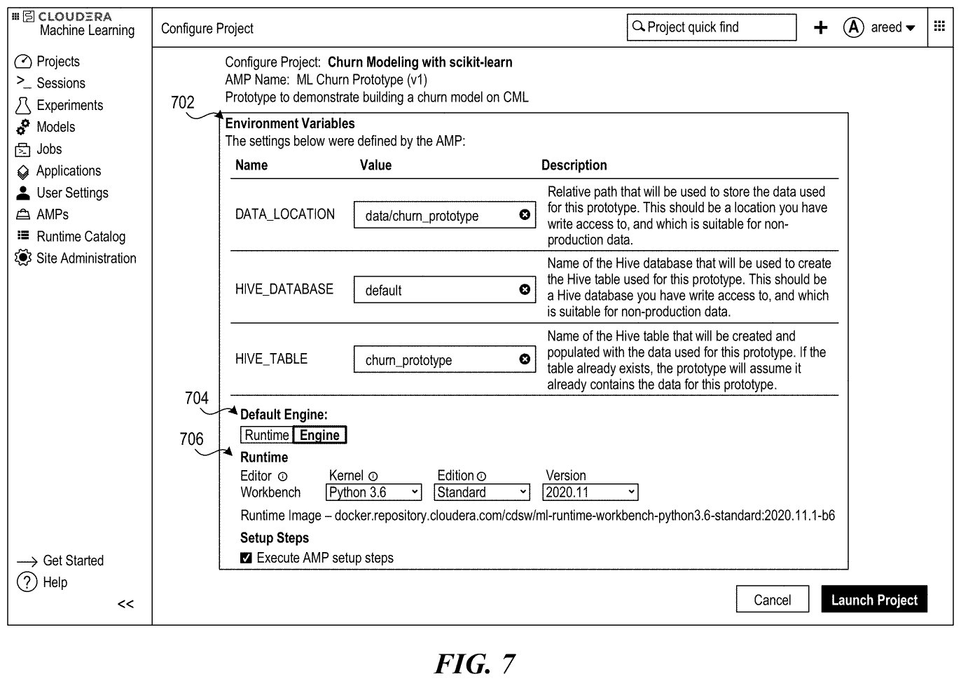

Assume, for example, that a user is interested in implementing an AMP shown in FIG. 3. Upon accessing the interface, the user may select the digital element in the left panel that is labeled “AMPs.” By selecting each AMP, the user may be able to read its description or review other relevant information as shown in FIG. 6. The relevant information may specify, for example, the model type (e.g., binary classification, multiclass classification, regression), the model goal (e.g., churn prediction, object identification, performance), the modeling algorithm (e.g., linear regression, logistic regression, decision tree, support vector machine, neural network), the output goal (e.g., explainability, prediction, understanding), and the like. After the AMP of interest has been selected, the user can select the digital element that is labeled “Configure Project” as shown in FIG. 6, and then the user can provide any information that is needed by the AMP as shown in FIG. 7. For example, the user may be prompted to input configuration values. The description may specify how to determine these configuration values. After the user selects the digital element that is labeled “Launch Project,” the AMP can be installed into a workspace. The installation process may take several seconds to several minutes depending on the nature of the AMP. When installation is complete, the user can select a digital element that is labeled “Overview” to read documentation for the AMP, explore its code and structure, etc.

### A. Creating New AMPs

One noteworthy use for AMPs is to showcase examples that are specific to a business or field by creating specialized AMPs. After a data science project has been built using the data platform, a user can package the data science project such that it can be added to the catalog of AMPs. In some embodiments, the data science project must be reviewed and approved by an administrator before its addition to the catalog of AMPs. The administrator may be associated with (e.g., employed by) an organization that operates the data platform. In other embodiments, the data science project is reviewed and approved by the data platform. For example, the data platform may autonomously review the data science project and its characteristics (e.g., model type, model goal, modeling algorithm, accuracy) and then determine whether one or more criteria are met. If the data science project meets the criteria, then the data platform may add the data science project to the catalog of AMPs.

Each AMP may require a separate metadata file, which can define the computing resources needed by the corresponding AMP, the setup steps for installing the corresponding AMP in a workspace, etc. Exemplary code for an AMP is provided below.

```
name: Deep Learning for Anomaly Detection
description: Apply deep learning models on the task of anomaly detection
specification_version: 1.0
prototype version: 1.0
api_version: 1
runtimes:
  editor: Workbench
  kernel: Python 3.6
  edition: Standard
engine_images:
  image_name: engine
  tags: 14
tasks:
  type: create_job
  name: Install Dependencies
  entity_label: install_deps
  script: cml/install_deps.py
  arguments: None
  cpu: 1
  memory: 4
  short_summary: Create job to install project dependencies
  environment:
    TASK_TYPE: CREATE/RUN_JOB
  kernel: python3
  type: run_job
  entity_label: install_deps
  short_summary: Running install dependencies job.
  type: create_job
  name: Train Model
  entity_label: train_model
  script: train.py
  arguments: None
  short_summary: Job to train and export model.
  cpu: 1
  memory: 3
  environment:
    TASK_TYPE: CREATE/RUN_JOB
  kernel: python 3
  type: run_job
  entity_label: train_model
  short_summary: Run model training job
  type: start_application
  name: Application to serve deep learning for anomaly detection UI
  short_summary: Create an application to serve the anomaly
    detection UI.
  subdomain: deepad
  script: app/backend/app.py
  environment_variables:
    TASK_TYPE: START_APPLICATION
  kernel: python3
```

Accordingly, the data structure that is representative of the AMP may include entries with respective data elements, such as name, description, version information, list of runtimes including details on dependent software versions, list of tasks to be performed by the AMP including details on code to execute, computational resources needed to implement the AMP. and the like.

### B. AMP Catalog

At a high level, an AMP catalog (or simply “catalog”) is a collection of AMPs that can be added to a workspace as a group. Upon accessing the data platform for the first time, users may be permitted to access a default catalog that contains AMPs developed or approved by the organization that operates the data platform. However, users may also be able to create their own catalogs, adding AMPs developed by their respective organizations.

Assume, for example, that a user is interested in creating a catalog. In this scenario, the user may create a human-readable configuration file—called a “catalog file”—that can be hosted by an Internet hosting service such as GitHub, Inc. Specifically, the catalog file could be hosted on either a public server or private server. The human-readable file may be created in a data-serialization language such as YAML or JSON. The catalog file can include information about each AMP in the corresponding catalog. Moreover, the catalog file can provide a link to the repository itself. Thus, the catalog file can contain descriptive information in addition to metadata for displaying AMPs included in the corresponding catalog. Table I includes descriptions of fields that could be included in the catalog file.

TABLE I
Descriptions of fields that could be included in a catalog file.

| Field Name | Type | Example | Description |
|---|---|---|---|
| name | string | name: Cloudera | Name of catalog, |
| | | | displayed as source |
| | | | in a prototype catalog |
| | | | tab. |
| entries | string | entries: | Contains the entries |
| | | | for each project. |
| title | string | Title: Churn | The title of the AMP, |
| | | Modeling | as displayed in the |
| | | | prototype catalog. |
| label | string | label: churn- | Labels used for |
| | | prediction | categorization and |
| | | | search. |
| short_description | string | short_description: | A short description of |
| | | Build a scikit-learn | the project. May |
| | | model | appear on the project |
| | | | tile in the prototype |
| | | | catalog. |
| long_description | string | long_description: >- | A longer description |
| | | This project | that may appear |
| | | demonstrates . . . | when a user clicks on |
| | | | the project tile. |
| image_path | string | image_path: >- | Path to the image file |
| | | https://raw.git . . . | that may be displayed |
| | | | in the prototype |
| | | | catalog. |
| tags | string | tags: Churn | For sorting in the |
| | | Prediction, Logistic | prototype catalog |
| | | Regression, . . . | pane. May |
| | | | correspond to the |
| | | | relevant information |
| | | | maintained for each |
| | | | AMP. |
| git_url | string | git_url: “https: . . . ” | Path to the repository |
| | | | for the project, in this |
| | | | case on Github. |
| is_prototype | boolean | is_prototype: true | Indicates whether |
| | | | AMP should be |
| | | | displayed in the |
| | | | prototype catalog. |
| | | | May be mutually |
| | | | exclusive with |
| | | | coming_soon. |
| coming_soon | Boolean | coming_soon: true | Causes AMP to be |
| | | | displayed in the |
| | | | prototype catalog with |
| | | | a “Coming Soon” |
| | | | watermark. May be |
| | | | mutually exclusive |
| | | | with is_prototype. |

For the purpose of illustration, exemplary code of a catalog file is provided below:

```
name: Cloudera
entries:
  title: Churn Modeling with scikit-learn
  label: churn-prediction
  short_description: Build scikit-learn model to predict churn using
  telco data.
  long_description: >−
    This project demonstrates how to build a logistic regression
    classification model to predict the probability that a group of
    customers will churn from a fictitious telecommunications
    company. In addition, the model is interpreted using a
    technique called Local Interpretable Model--agnostic
    Explanations (LIME). The logistic regression and LIME
    models are deployed using the data platform's real-time
    model deployment capability and interact with a Flask-based
    web application.
  image_path: >−
    https://raw.githubusercontent.com/cloudera/Applied-ML-
    Prototypes/master/images/churn-prediction.jpg
  tags:
    - Churn Prediction
    - Logistic Regression
    - Explanability
    - LIME
  git_url: https://github.com/cloudera/CML_AMP_Churn_Prediction
  is_prototype: true
```

One benefit of this approach to maintaining catalog files for catalogs is the ability to create modifiable/editable copies of the original AMP catalog, which maintains its own distinct identity. These modifiable/editable copies may be called “forks” of existing catalogs. For example, the data platform may maintain a default catalog that is available to all users. In order to host the default catalog internally (e.g., on a personal computing device maintained by a user, her organization, etc.), a fork of the default catalog can be created. In this scenario, the uniform resource locators (“URLs”) and metadata in the forked catalog can be updated by the data platform to point to the appropriate internal resources. Thus, the data platform may tailor the forked catalog to account for its instantiation on the personal computing device.

### C. Project Specification

As mentioned above, data science projects involving AMPs may include, or be associated with, metadata files that provide configuration details, setup details, and the like. For example, these details may include environment variables, as well as tasks to be run on startup. In some embodiments, the metadata file is a YAML file that has a predetermined naming structure (e.g., .project-metadata.yaml). Moreover, the metadata file may need to be placed in a specific location, for example, the root directory of the data science project, for reference purposes.

Fields for the metadata file may generally be string fields. String fields are normally constrained by a fixed character size. For example, string(64) may be constrained to contain at most 64 characters while string(200) may be constrained to contain at most 200 characters. Table II includes descriptions of fields that could be included in the metadata file.

TABLE II
Descriptions of fields that could be included in a metadata file.

| Field Name | Type | Example | Description |
|---|---|---|---|
| name | string(200) | ML Demo | The name of the |
| | | | project prototype. |
| | | | Prototype names |
| | | | may not need to |
| | | | be unique. |
| description | string(2048) | This demo | A description of |
| | | shows off | the project |
| | | interesting | prototype. |
| | | applications of | |
| | | ML. | |
| author | String(64) | Cloudera | The author of the |
| | | Engineer | project prototype. |
| | | | Could be the |
| | | | name of an |
| | | | individual, team, or |
| | | | organization. |
| date | date string | “2020 Aug. 11” | The date that the |
| | | | project prototype |
| | | | was last modified. |
| | | | It may need to be |
| | | | in a predetermined |
| | | | format (e.g., |
| | | | “YYYY-MM-DD”). |
| specification_ | string(16) | 0.1 | The version of the |
| version | | | metadata file |
| | | | specification to |
| | | | use. |
| prototype_ | string(16) | 1.0 | The version of the |
| version | | | project prototype. |
| shared_ | Number | 0.0625 | Additional shared |
| memory_limit | | | memory available |
| | | | to sessions |
| | | | running in the |
| | | | project prototype. |
| environmental_ | environment | See below. | Global |
| variables | variables | | environment |
| | object | | variables for the |
| | | | project prototype. |
| feature_ | feature_ | See below. | A list of feature |
| dependencies | dependencies | | dependencies of |
| | | | the AMP. A |
| | | | missing |
| | | | dependency in the |
| | | | workspace may |
| | | | block creation of |
| | | | the AMP. |
| engine_images | engine_ | See below. | Engine images to |
| | images | | be used with the |
| | | | AMP. What is |
| | | | specified here is |
| | | | generally a |
| | | | recommendation, |
| | | | and therefore may |
| | | | not prevent the |
| | | | user from |
| | | | launching the AMP |
| | | | with non- |
| | | | recommended |
| | | | engine images. |
| runtimes | runtimes | See below. | Runtimes to be |
| | | | used with the |
| | | | AMP. What is |
| | | | specified here is |
| | | | generally a |
| | | | recommendation, |
| | | | and therefore may |
| | | | not prevent the |
| | | | user from |
| | | | launching the AMP |
| | | | with non- |
| | | | recommended |
| | | | runtimes. |
| tasks | task list | See below. | A sequence of |
| | | | tasks, such as |
| | | | running jobs or |
| | | | deploying models, |
| | | | to be run after |
| | | | project import. |

The metadata file can optionally define any number of global environment variables for the data science project under the environment field. This field may be an object, containing keys representing the names of the environment variables and values representing details about those environment variables. Below is an example in which four environment variables are created:

```
environment_variables:
  AWS_ACCESS_KEY:
    default: “”
    description: “Access Key ID for accessing S3 bucket”
  AWS_SECRET_KEY:
    default: “”
    description: “Secret Access Key for accessing S3 bucket”
    required: true
  HADOOP_DATA_SOURCE:
    default: “”
    description: “S3 URL to large data set”
    required: false
  MODEL_REPLICAS:
  default: “3”
    description: “Number of model replicas, 3 is standard for
    redundancy”
    required: true
```

AMPs might depend on some optional features of a workspace. The feature_dependencies field may accept a list of such features. Unsatisfied feature dependencies that are deemed mandatory may prevent the AMP from being launched in a workspace, and an appropriate error message may be displayed. As an example, certain model metrics may need to be defined or achieved in order for the AMP to be launched. Meanwhile, unsatisfied feature dependencies that are deemed optional may not prevent the AMP from being launched in a workspace, though the user may still be notified of the unsatisfied feature dependencies (e.g., with an appropriate warning message).

The engine_images field may accept a list of engine_image objects that are defined as follows:

```
image_name: the_name_of_the_engine_image # string
  tags: # list of strings
    the_tag_of_engine_image
    ...
```

This example specifies the official engine image with version 11 or 12:

```
engine_images:
  image_name: engine
  tags:
    12
    11
```

Meanwhile, this example specifies the most recent version of the dataviz engine image in the workspace:

```
engine_images:
  image_name: cmldataviz
  image_name: cdswdataviz
```

Note that when tags are not specified, the most recent version of the engine image with the matching name can be returned.

The runtimes field may accept a list of runtimes objects that are defined as follows:

```
editor: the_name_of_the_editor # case-sensitive string required. e.g.
  Workbench, Jupyter, etc. (how it appears in the UI)
kernel: the_kernel # case-sensitive string required. e.g. Python 3.6,
  Python 3.8, R 3.6, etc. (how it appears in the UI)
edition: the_edition # case-sensitive string required. e.g. Standard, Nvidia
  GPU, etc. (how it appears in the UI)
version: the_short_version # case-sensitive string optional. E.g. 2021.03,
  2021.05, etc. (how it appears in the UI)
addons: the_list_addons_needed # list of case-sensitive strings optional.
  e.g. Spark 2.4.7 - CDP 7.2.11 - CDE 1.13, etc. (how it appears in
  the UI)
```

The runtimes field can be defined on a per-task or per-project basis.

Meanwhile, the task list may define the tasks that can be automatically run on project import. Each task may be run sequentially in the order specified in the metadata file. Table III includes descriptions of fields that could be included in the task list.

TABLE III
Descriptions of fields that could be included in a task list.

| Field Name | Type | Example | Description |
|---|---|---|---|
| type | string | create_job | See below for |
| | | | a list of allowed |
| | | | task types. |
| short_summary | string | Creating a job that | A short summary |
| | | will do a task. | of what this task |
| | | | is doing. |
| long_summary | string | Creating a job that | A long summary |
| | | will do a specific task. | of what this task |
| | | This is important | is doing. |
| | | because it leads up to | |
| | | this next task. | |

There are various tasks that can be specified in the type field, including create job and run job.

### D. Implementation

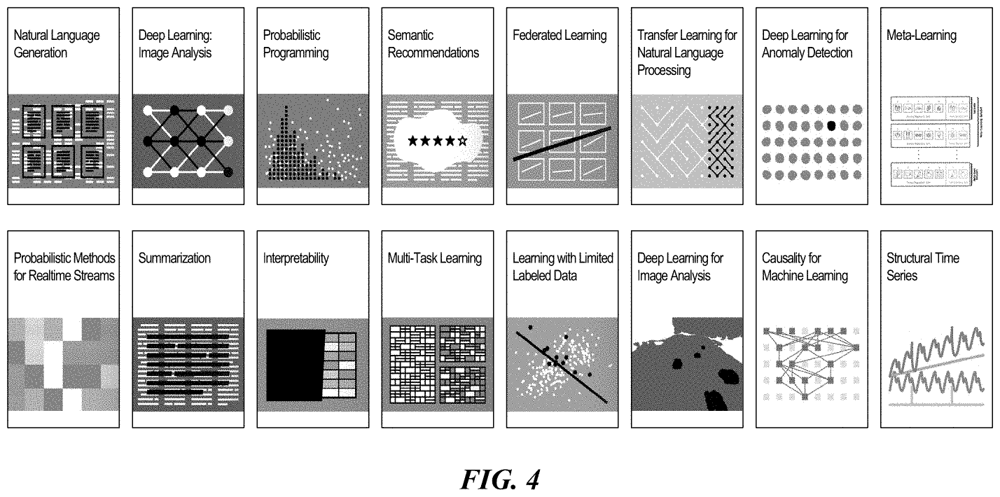

As mentioned above, machine learning is still not fully accessible despite being impactful. Data science projects involving machine learning may not make it to production for many reasons, including limited expertise, inadequate tooling, lack of best practices, infrastructure issues, data issues, and the like. AMPs were developed to address the accessibility problem. Specifically, AMPs were designed to contribute the following:
Provide reference implementations for different machine learning challenges.
Provide underlying infrastructure that is readily manipulable or implementable through easy to use interfaces. Each step may be specified on an interface, or each step may be specified in a catalog file or metadata file.
Automate the export, import, and deployment of entire data science projects represented by sequences of tasks.
   Examples of machine learning challenges for which AMPs can be developed are shown in FIG. 4.

For a machine learning use case to make it to production, several criteria must typically be met. First, the data has to be available in a scale and format that is appropriate for the use case in question. Second, data transformations, feature engineering, and model training have to be done to build a model. Third, models have to be made available to the applications that require them. Fourth, applications have to be built—properly utilizing the models—to serve specific outcomes.

AMPs target individual machine learning use cases—packing up the data, data operations, model training, model serving, and applications that make up those use cases. After an AMP has been deployed by a data platform, all of the data and code that make up the AMP may be available within a data science project for the necessary work to incorporate user-specific data, as well as enable further customization. Said another way, the data and code that make up the AMP may be readily manipulable or extendable to accommodate user-specific data that is provided as input. To facilitate implementation, AMPs may be available through a catalog as discussed above. The catalog can be updated as new AMPs are developed and made publicly available to users of the data platform. Moreover, users may be able to develop their own AMPs, for example, to reflect organizational best practices or address organizational specificities. Through the creation of a customized catalog, a user may be able to make these AMPs available to other users associated with the same organization. Over time, it is expected that the number of AMPs will continue to grow.

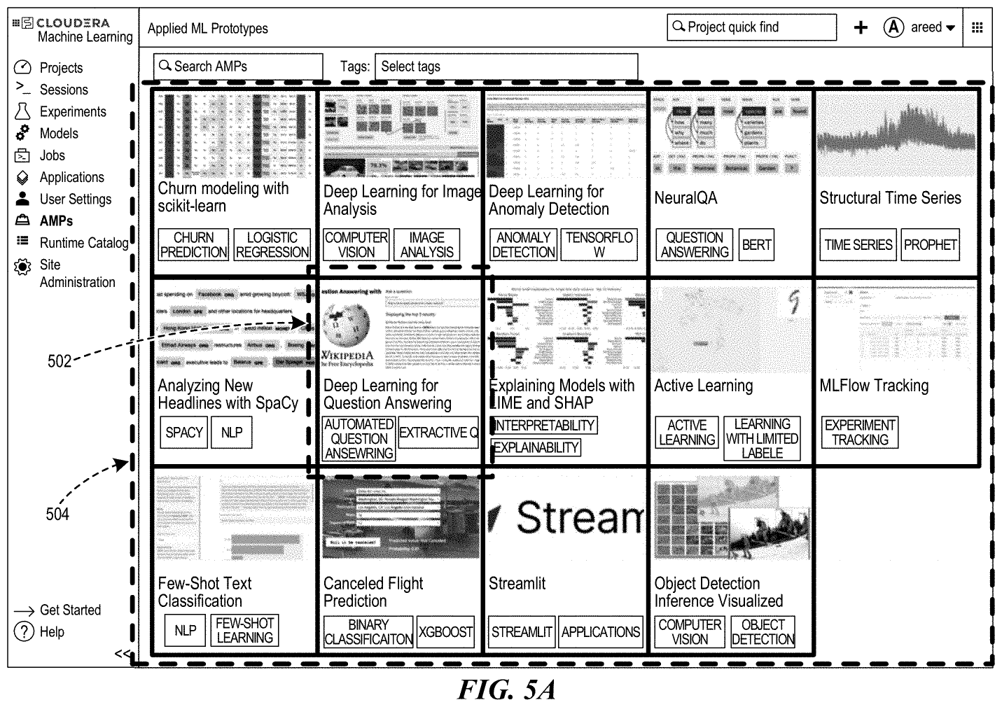

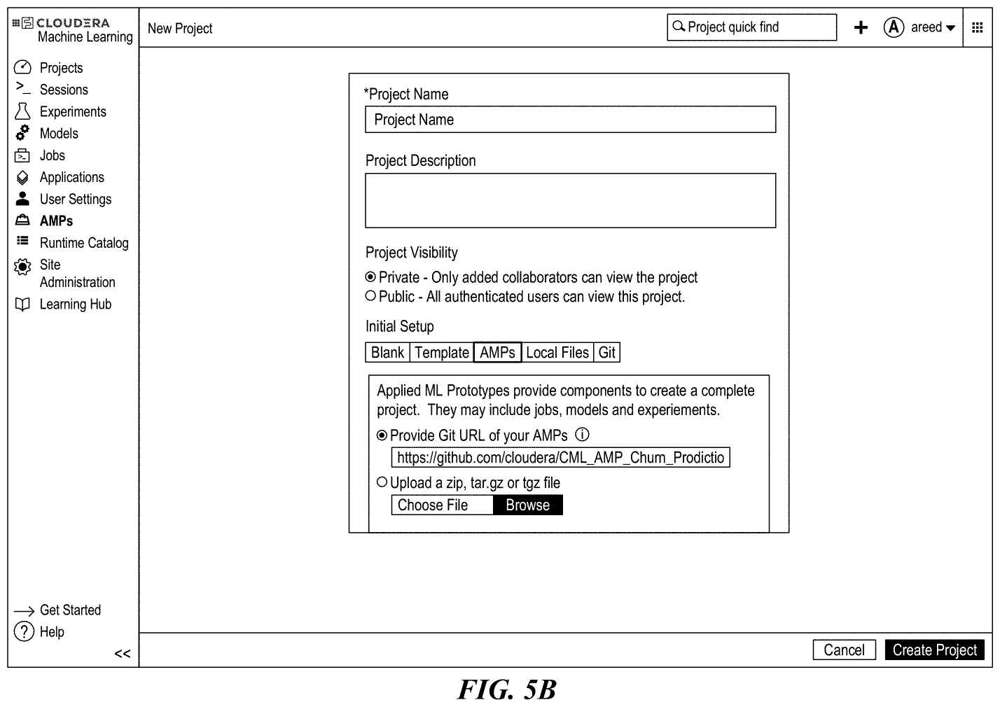

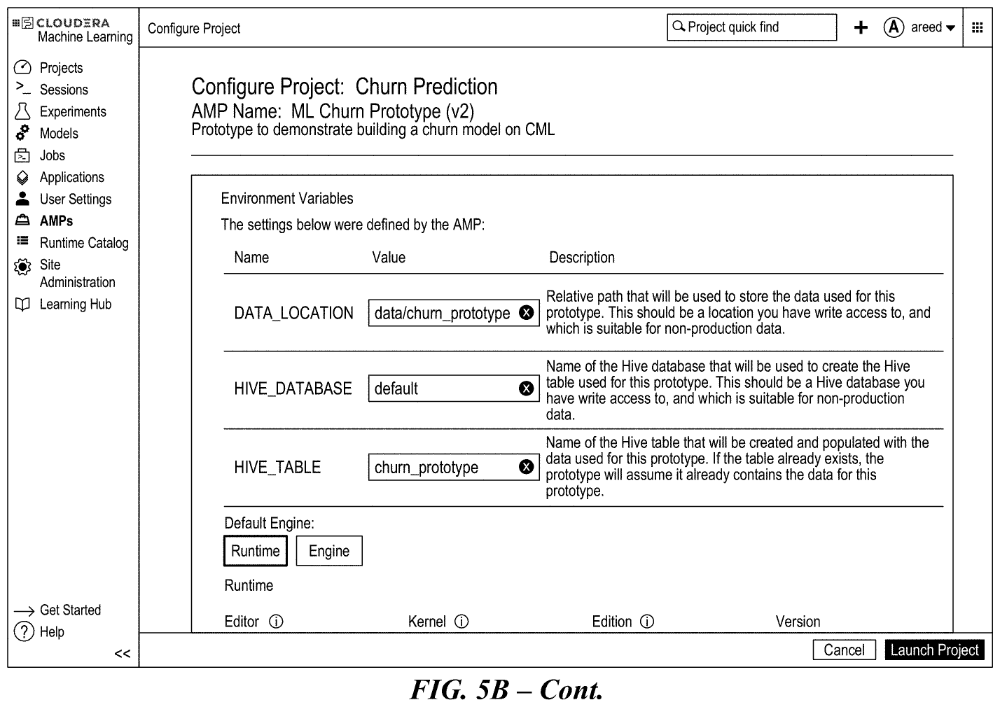

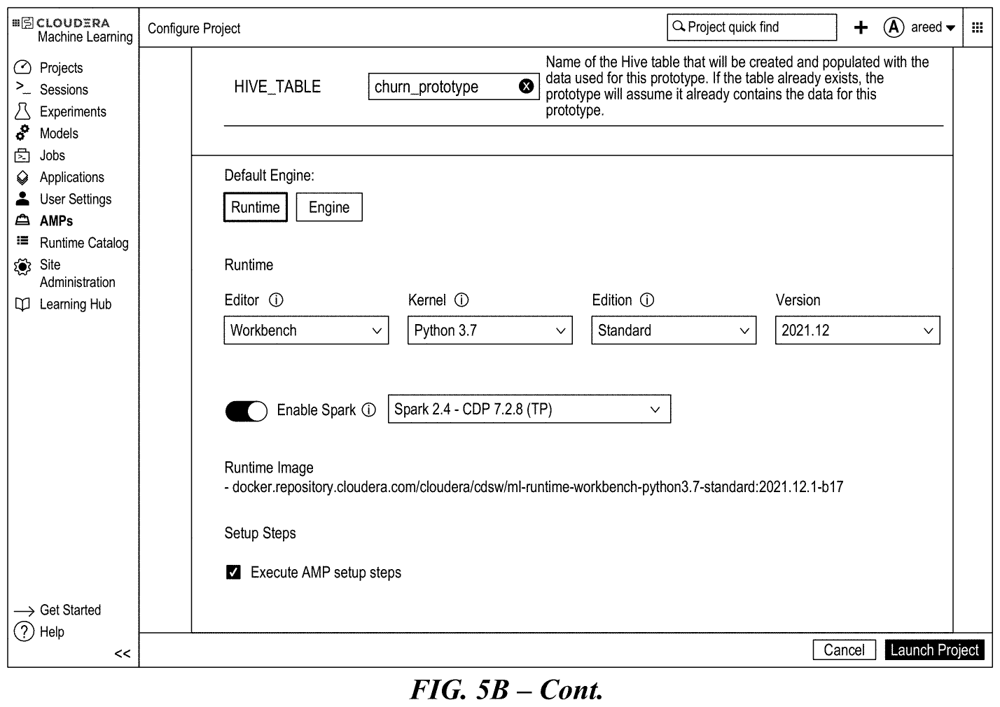

When implemented through the data platform, AMPs have two main components as shown in FIG. 5A. First, the AMPs 502 themselves that serve as project repositories that contain all of the code and data needed to reproduce working data science projects. Each AMP 502 may contain a configuration file at its root that specifies a “pipeline” of software-implemented tasks that will rebuild the data science project. Second, the catalog 504 that is representative of a collection of AMPs 502. The catalog 504 may specify metadata about each AMP 502 in the catalog 504. The data platform may maintain a default catalog, though users may build and maintain their own catalogs as discussed above.

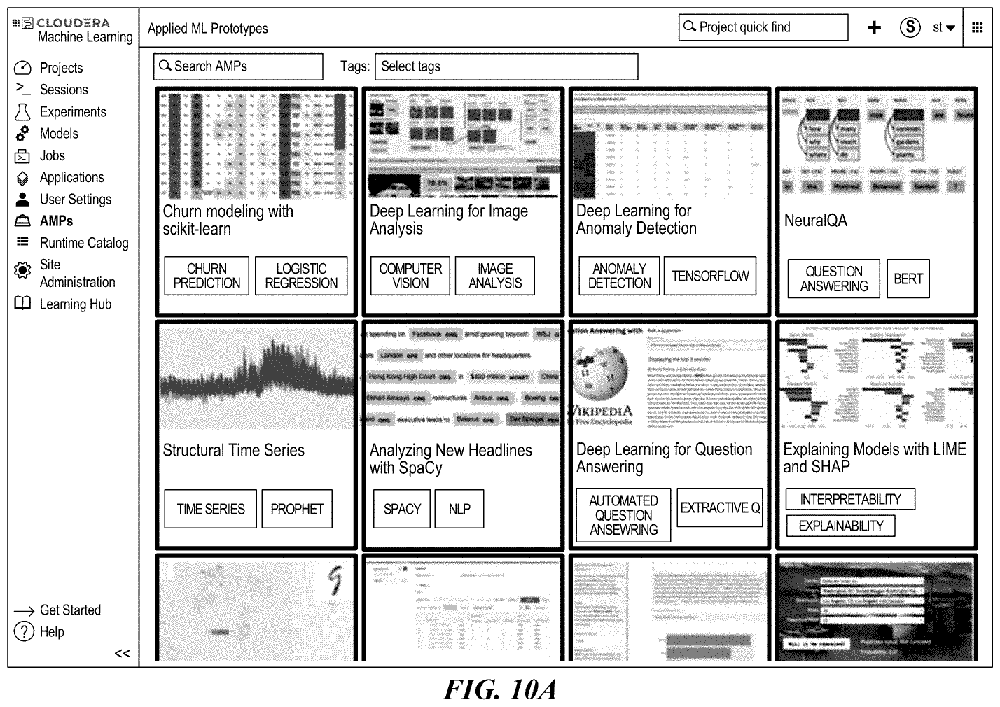

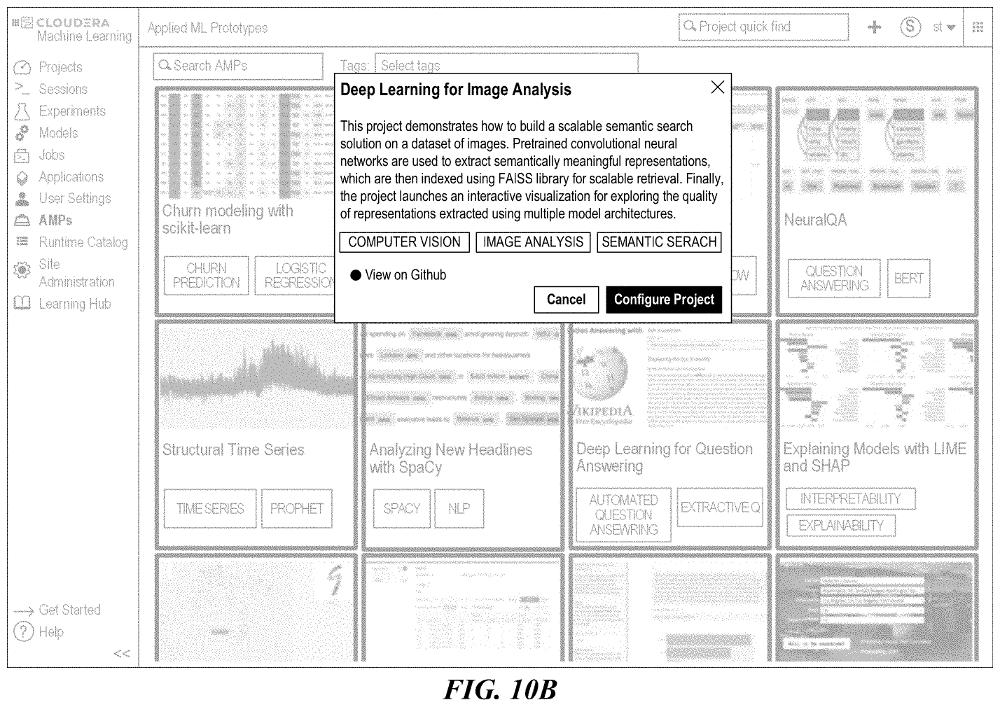

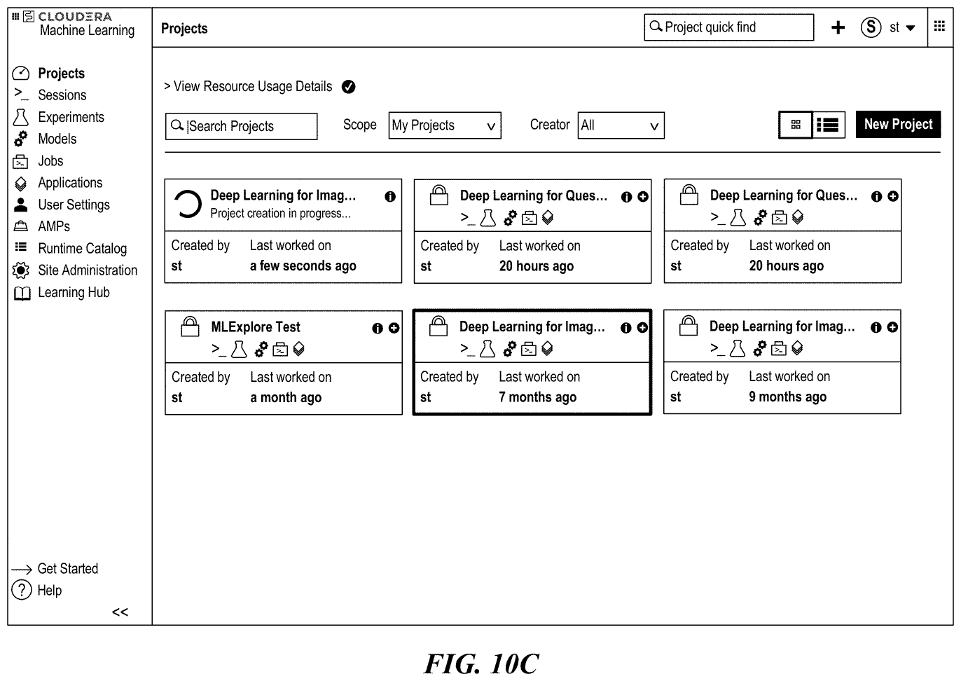

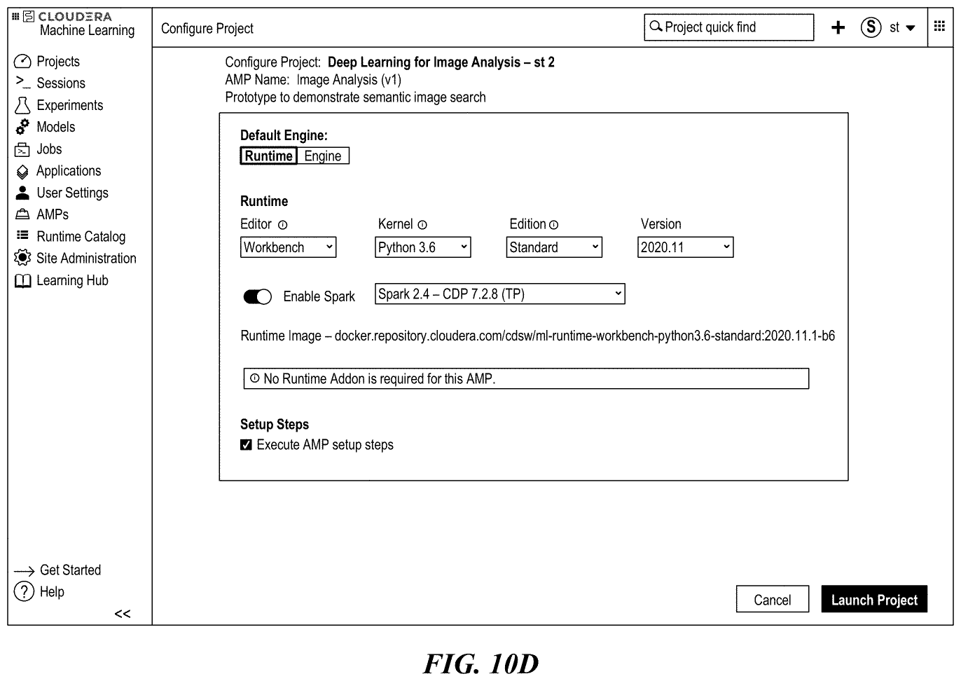

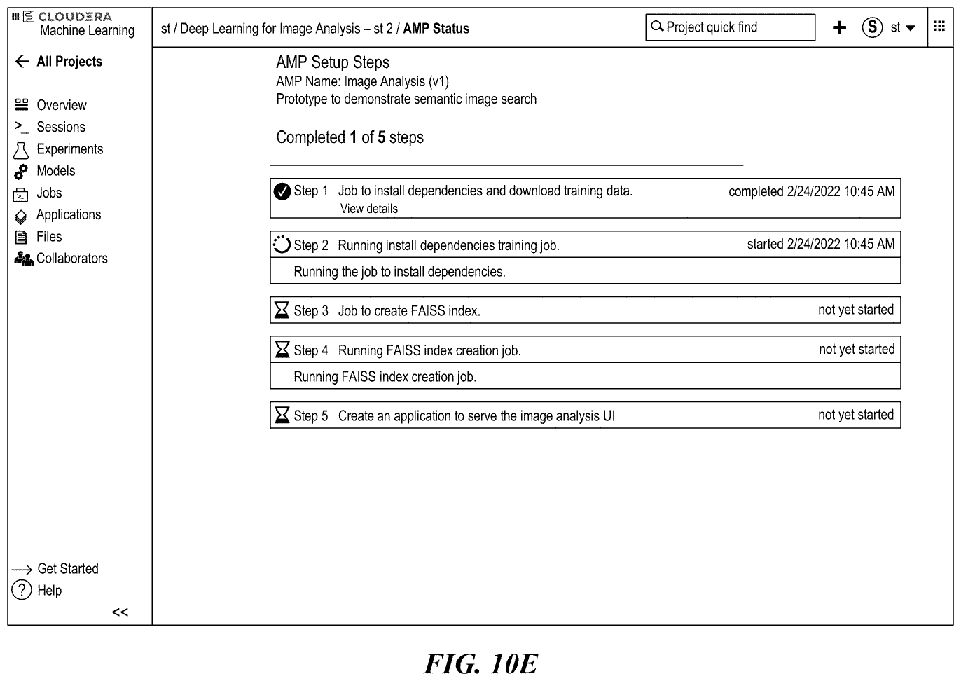

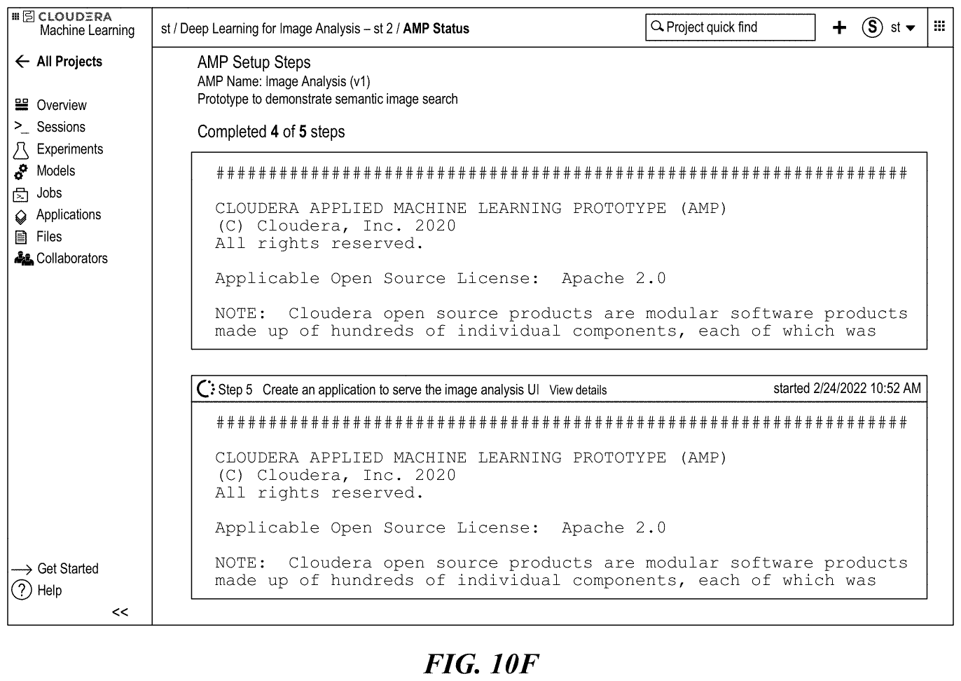

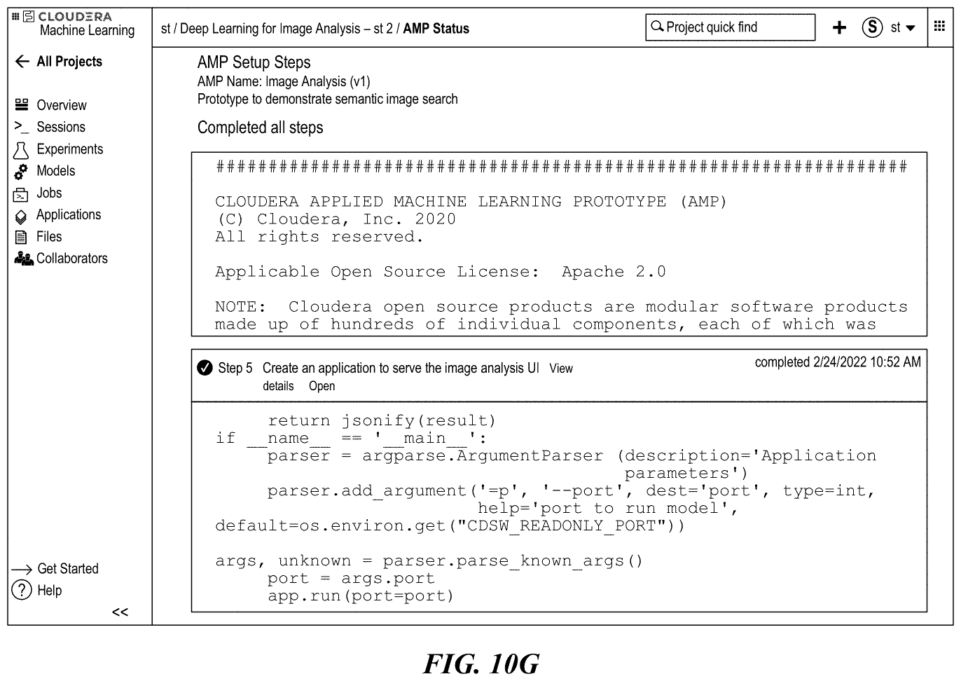

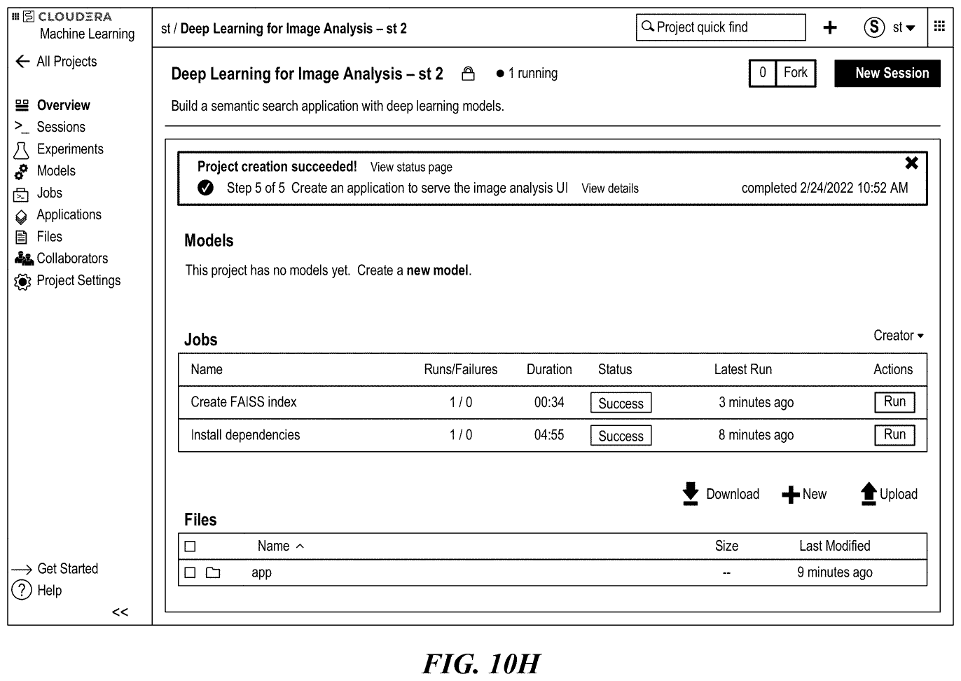

Advantageously, the data platform may allow AMPs to be launched from a workspace in several ways. First, a user may launch an AMP from the catalog by selecting an “AMP tile,” clicking the digital element labeled “Launch as Project,” and then clicking the digital element labeled “Configure Project,” as shown in FIGS. 6 and 10B. Second, a user may launch an AMP from the projects interface by selecting the digital element labeled “New Project,” inputting a project name, selecting the digital element labeled “AMPs” as the initial setup option, selecting the digital element labeled “Create Project,” and then selecting the digital element labeled “Configure Project,” as shown in FIG. 5B.

Launching an AMP causes the data platform to perform several steps “under the hood.” Specifically, the data platform can clone the repository that corresponds to the AMP, check for a metadata file in the root of the repository, and then initiate an automatic execution of the steps specified in the metadata file to create the data, models, and applications necessary to recreate the data science project. Each step may correspond to a job, session, experiment, model endpoint, or application that is executable or implementable by the data platform.

In FIG. 6, an interface is shown illustrating how to implement an AMP. A user may initially select the corresponding “AMP tile” 602 to invoke a secondary panel 604 that includes relevant information. From this secondary panel 604, the user can elect to implement the AMP in a project by selecting the digital element 606 labeled “Configure Project.” Thereafter, the user can configure the project through the interface shown in FIG. 7. While AMP-specific parameters may be preconfigured in the corresponding metadata file that is maintained by, or accessible to, the data platform, some or all of those parameters may be updated through the interface. Examples of such parameters include environment variables 702, engine-specific information 704, and runtime-specific information 706.

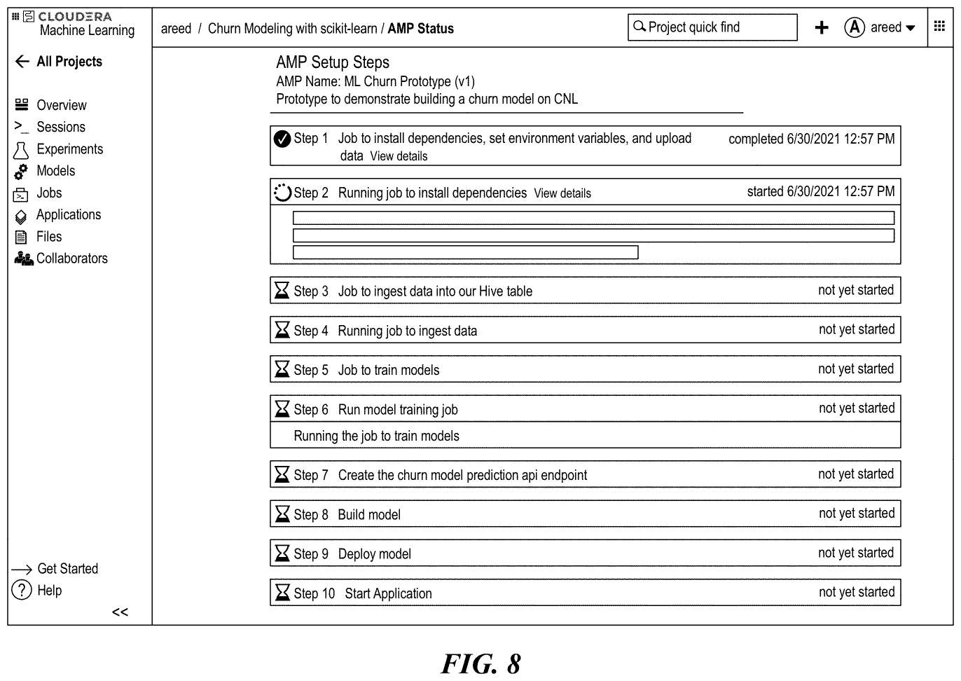

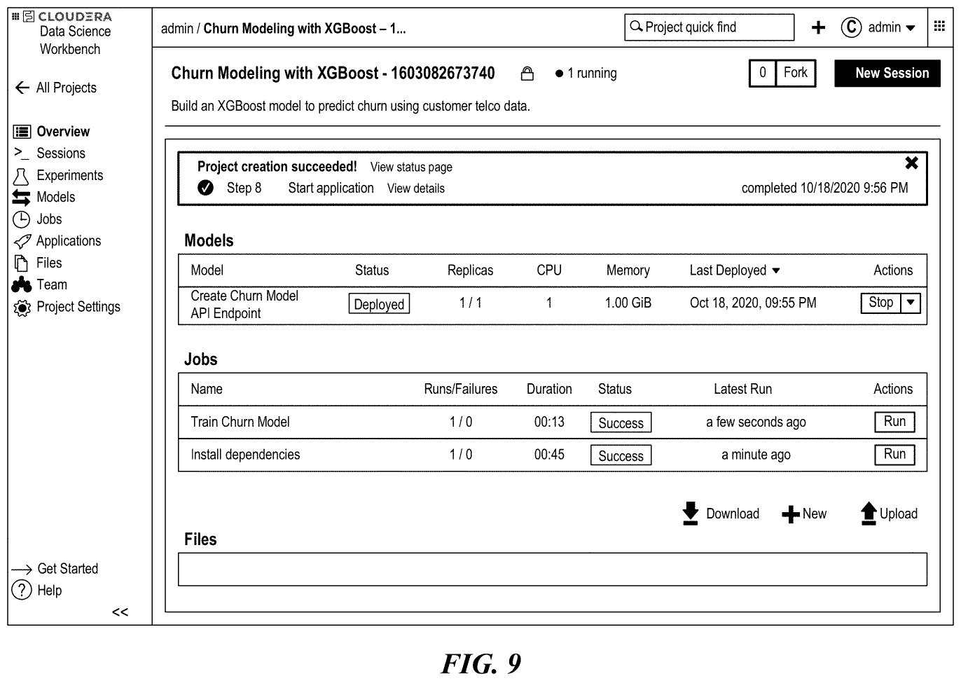

After receiving input indicative of a confirmation of the parameters (e.g., a selection of the digital element labeled “Launch”), the data platform can initiate construction of the data science project. Said another way, the data platform can begin building the data, models, and applications needed for the data science project using the AMP assets maintained in the repository. As shown in FIG. 8, progression of the data platform as it completes the necessary steps may be shown in another interface. FIG. 9 shows an interface that may be presented after construction of the data science project is complete. In addition to indicating whether the data science project was successfully created, the interface may indicate how many runs were needed, whether any failures occurred, the total duration of each step, and other relevant information.

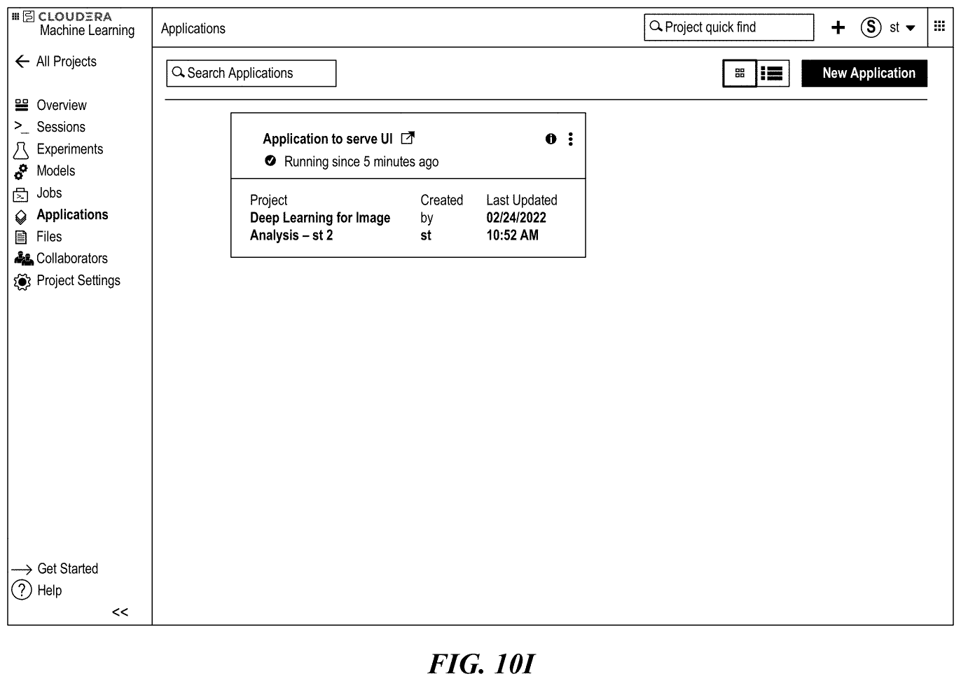

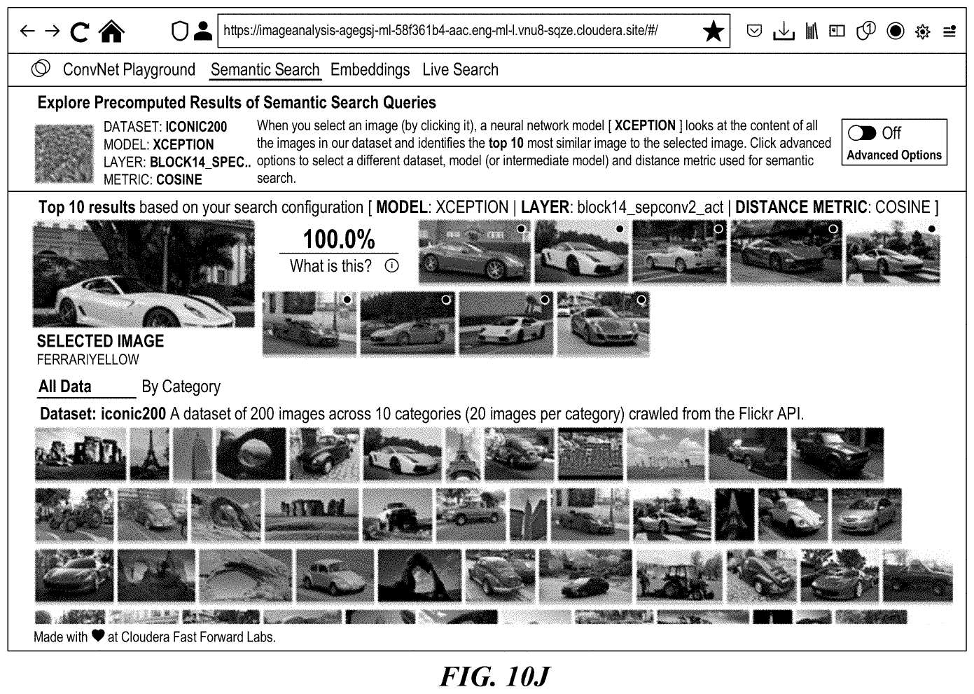

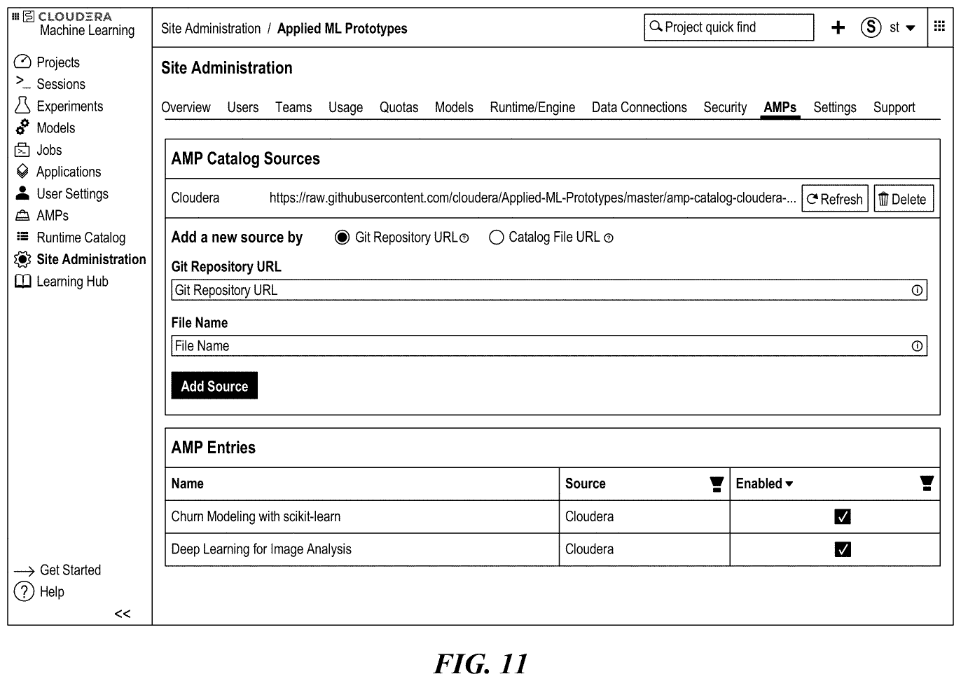

FIGS. 10A-J include a series of interfaces—corresponding roughly to FIGS. 5-9—that illustrate how a user can instantiate an AMP as a data science project that, in this example, utilizes deep learning for image analysis, specifically by identifying a number of images (here, ten) that are most similar to the image provided as input. FIG. 11, meanwhile, includes an interface that shows how catalogs may be “pointed to” within the context of the data platform. In FIG. 11, the catalog is “pointed to” using a Git repository URL. However, the catalog could be “pointed to” in other ways as mentioned above. For example, the location could be identified using a catalog file URL, or the location could be identified by identifying the folder or file in which the catalog is stored locally.

### Methodologies for Creating, Implementing, and Maintaining AMPs

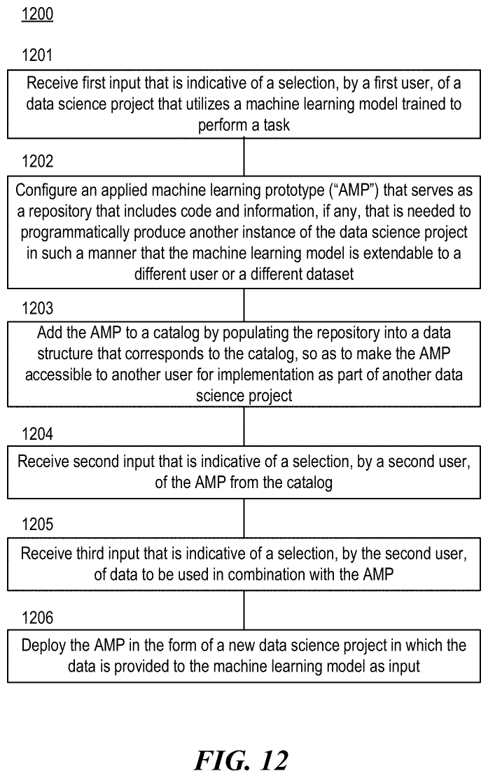

FIG. 12 includes a flow diagram of a process 1200 for creating an AMP based on an existing data science project. Initially, a data platform can receive input that is indicative of a selection, by a user, of a data science project that utilizes a machine learning model trained to perform a task (step 1201). As mentioned above, the data platform may enable users to create data science projects in workspaces that are accessible via interfaces on respective computing devices. Accordingly, the data science project may be constructed through an interface that is generated by the data platform.

Thereafter, the data platform can configure an AMP that serves as a repository that includes code and information, if any, that is needed to programmatically reproduce another instance of the data science project in such a manner that the machine learning model is extendable to a different user or a different dataset (step 1202). At a high level, the data platform may genericize aspects of the data science project, so that its underlying mechanisms—namely, its code and machine learning model—can be applied in a different context. As mentioned above, in some embodiments, the data platform only configures the AMP in response to receiving approval to do so. Thus, the data platform may receive second input that is indicative of an approval, by an administrator, of the data science project, and the data platform may configure the AMP in response to receiving the second input.

The data platform can then add the AMP to a catalog by populating the repository into a data structure that corresponds to the catalog, so as to make the AMP accessible to another user for implementation as part of another data science project (step 1203). In some embodiments, the AMP is only made available to other users that are part of the same organization (e.g., company) as the user that developed the data science project. In other embodiments, the AMP is made available to all users of the data platform. As mentioned above, the catalog may include multiple AMPs that users are permitted to deploy. Each of the multiple AMPs may be associated with a different repository, and therefore the repository may be one of multiple repositories maintained in the data structure. In the data structure, each of the multiple AMPs may be accompanied by a metadata file that defines an operational characteristic of the corresponding AMP. For example, a metadata file may specify the computing resources needed by the corresponding AMP and/or setup sets for installing the corresponding AMP.

At some point thereafter, the data platform may receive second input that is indicative of a selection, by a second user, of the AMP from among the multiple AMPs (step 1204). For example, the second user may select the AMP through an interface such as the one shown in FIG. 5A or FIG. 10A. Moreover, the data platform may receive third input that is indicative of a selection, by the second user, of data to be used in combination with the AMP (step 1205). In some embodiments, the selection may be made as part of the AMP instantiation process as discussed above with reference to FIGS. 6-8. In other embodiments, the selection may be made either before the AMP instantiation process commences or after the AMP instantiation process concludes, for example, through the workspace into which the AMP is to be instantiated. The data platform may deploy, on behalf of the second user, the AMP in the form of a new data science project in which the data is provided to the machine learning model as input (step 1206). Specifically, the data platform may construct the new data science project based on the code and the information, if any, that is included in the repository corresponding to the AMP. As discussed above, the data platform may adjust the new data science project on behalf of the second user, as necessary, to accommodate the data.

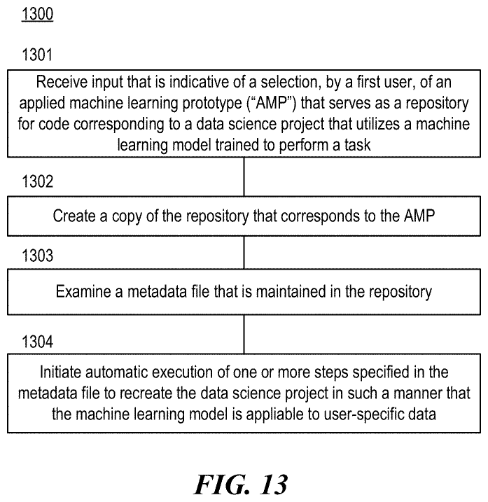

FIG. 13 includes a flow diagram of a process 1300 for implementing an AMP as part of a new data science project. Initially, the data platform may receive input that is indicative of a selection, by a user, of the AMP that serves as a repository for code corresponding to a data science project that utilizes a machine learning model trained to perform a task (step 1301). As mentioned above, the AMP may be included in a catalog that is accessible to the user, and the catalog may include multiple AMPs that correspond to different types of data science projects, different types of machine learning models, etc. In response to receiving the input, the data platform can create a copy of the repository that corresponds to the AMP (step 1302). Moreover, the data platform can examine a metadata file that is maintained in the repository (step 1303). The metadata file may include information regarding one or more parameters of the AMP. For example, the metadata file may include information pertaining to an environment variable, a software-implemented engine responsible for executing the code, or a runtime environment. In some embodiments, the data platform permits these parameters to be reviewed, confirmed, or altered, by the user, through an interface as part of the AMP instantiation process, as shown in FIG. 7.

Then, the data platform can initiate automatic execution of one or more steps specified in the metadata file to recreate the data science project in such a manner that the machine learning model is applicable to user-specific data (step 1304). For example, the data platform may cause digital presentation of the information included in the metadata file on an interface and, in response to receiving second input that is indicative of a confirmation, by the user, of the information, construct a new instance of the data science project using assets included in the copy of the repository. The assets could include the code and information that is needed to programmatically recreate the new instance of the data science project. Moreover, the data platform may determine whether alteration of the machine learning model is necessary for the new instance of the data science project to be suitable for analysis of the user-specific data. In the event that the data platform determines that an alteration of the machine learning model is necessary, the data platform can implement the alteration on behalf of the user. In some embodiments, the data platform keeps the user apprised of progress by causing digital presentation of an indicium that visually illustrates progression as the new instance of the data science project is being constructed. FIG. 8 includes an interface that has examples of such indicia.

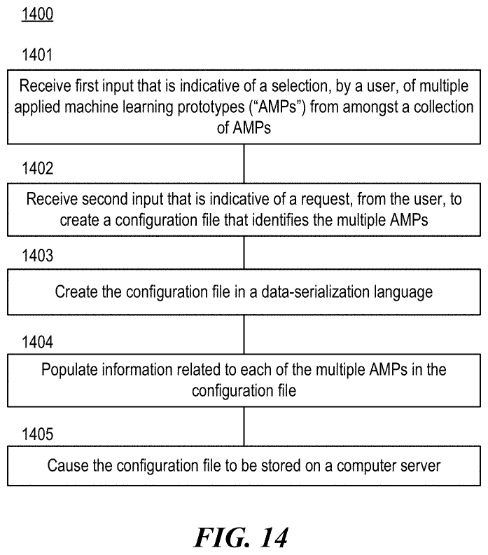

FIG. 14 includes a flow diagram of a process 1400 for creating a collection of AMPs, each of which corresponds to a different data science project that utilizes machine learning to address a problem and/or perform a task. Initially, the data platform may receive first input that is indicative of a selection, by a user, of multiple AMPs from amongst a collection of AMPs (step 1401). The collection of AMPs may correspond to a general catalog that is accessible to all users of the data platform by default. As mentioned above, each of the multiple AMPs may serve as a separate repository that includes code that is needed to programmatically produce another instance of the corresponding data science project that utilizes machine learning. Then, the data platform can receive second input that is indicative of a request, from the user, to create a human-readable configuration file that identifies the multiple AMPs (step 1402). The data platform can then create the human-readable configuration file in a data-serialization language (step 1403). For example, the data platform may create the human-readable configuration file in YAML or JSON. In the human-readable configuration file, the data platform can populate information related to each of the multiple AMPs (step 1404). Accordingly, the human-readable configuration file may serve as a summary of the contents of the catalog. For example, the human-readable configuration file may include descriptions of the multiple AMPs, as well as a link to the corresponding repository for each of the multiple AMPs.

The data platform can then cause the human-readable configuration file to be stored on a computer server (step 1405). This may result in the human-readable configuration file to be accessible to other users who are members of the same group as the user. For example, the human-readable configuration file could be made available to all users of the data platform, or the human-readable configuration file could be made available to other users who are employees of the same organization as the user. In some embodiments, the computer server is a public computer server that is part of the same server system on which the data platform resides. In other embodiments, the computer server is a private computer server, for example, that is maintained by, or accessible to, an organization of which the user is an employee.

As mentioned above, this approach to creating a configuration file that includes either references (e.g., links) to repositories of AMPs (or the repositories themselves) allows the catalog to be readily forked. The data platform may fork the configuration file, thereby creating a new catalog, in response to receiving input that is indicative of a selection, by a second user, of the same multiple AMPs from amongst the collection of AMPs. Similarly, the data platform may fork the configuration file, thereby creating a new catalog, in response to receiving input that is indicative of a selection, by the second user, of the catalog itself. Once forked, the new catalog may be readily editable, for example, by allowing the second user to add new AMPs thereto or delete existing AMPs therefrom.

### Processing System

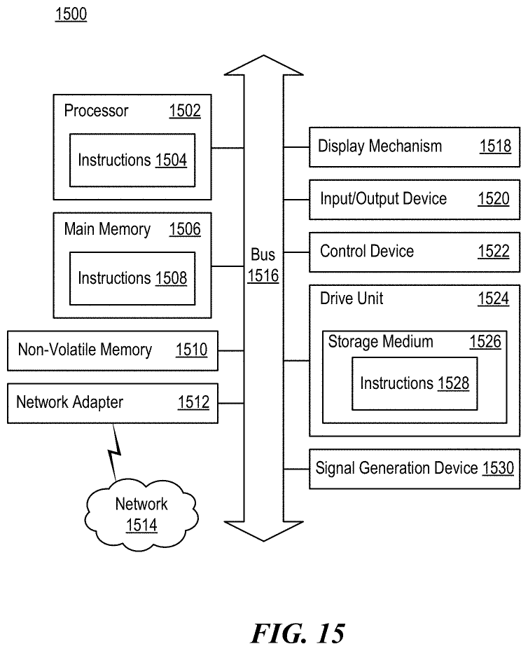

FIG. 15 is a block diagram illustrating an example of a processing system 1500 in which at least some of the operations described herein can be implemented. For example, components of the processing system 1500 may be hosted on a computing device that includes a data platform, or components of the processing system 1500 may be hosted on a computing device with which a user interacts with a data platform (e.g., via interfaces).

The processing system 1500 may include a processor 1502, main memory 1506, non-volatile memory 1510, network adapter 1512, display mechanism 1518, input/output device 1520, control device 1522, drive unit 1524 including a storage medium 1526, or signal generation device 1530 that are communicatively connected to a bus 1516. Different combinations of these components may be present depending on the nature of the computing device in which the processing system 1500 resides. The bus 1516 is illustrated as an abstraction that represents one or more physical buses or point-to-point connections that are connected by appropriate bridges, adapters, or controllers. Thus, the bus 1516 can include a system bus, a Peripheral Component Interconnect (“PCI”) bus or PCI-Express bus, a HyperTransport or industry standard architecture (“ISA”) bus, a small computer system interface (“SCSI”) bus, a universal serial bus (“USB”), inter-integrated circuit (“I²C”) bus, or an Institute of Electrical and Electronics Engineers (“IEEE”) standard 1394 bus (also called “Firewire”).

While the main memory 1506, non-volatile memory 1510, and storage medium 1526 are shown to be a single medium, the terms “machine-readable medium” and “storage medium” should be taken to include a single medium or multiple media (e.g., a centralized or distributed database and associated caches and computer servers) that store one or more sets of instructions 1528. The terms “machine-readable medium” and “storage medium” shall also be taken to include any medium that is capable of storing, encoding, or carrying instructions for execution by the processing system 1500.

In general, the routines executed to implement embodiments of the present disclosure may be implemented as part of an operating system or a specific computer program. A computer program typically comprises instructions (e.g., instructions 1504, 1508, 1528) set at various times in various memory and storage devices in a computing device. When read and executed by the processor 1502, the instructions cause the processing system 1500 to perform operations in accordance with aspects of the present disclosure.

Further examples of machine- and computer-readable media include recordable-type media, such as volatile memory devices and non-volatile memory devices 1510, removable disks, hard disk drives, and optical disks (e.g., Compact Disk Read-Only Memory (“CD-ROMs”) and Digital Versatile Disks (“DVDs”)), and transmission-type media, such as digital and analog communication links.

The network adapter 1512 enables the processing system 1500 to mediate data in a network 1514 with an entity that is external to the processing system 1500 through any communication protocol supported by the processing system 1500 and the external entity. The network adapter 1512 can include a network adaptor card, a wireless network interface card, a router, an access point, a wireless router, a switch, a multilayer switch, a protocol converter, a gateway, a bridge, bridge router, a hub, a digital media receiver, a repeater, or any combination thereof.

### Remarks

The foregoing description of various embodiments of the claimed subject matter has been provided for the purposes of illustration and description. It is not intended to be exhaustive or to limit the claimed subject matter to the precise forms disclosed. Many modifications and variations will be apparent to one skilled in the art. Embodiments were chosen and described in order to best describe the principles of the invention and its practical applications, thereby enabling those skilled in the relevant art to understand the claimed subject matter, the various embodiments, and the various modifications that are suited to the particular uses contemplated.

Although the Detailed Description describes certain embodiments and the best mode contemplated, the technology can be practiced in many ways no matter how detailed the Detailed Description appears. Embodiments can vary considerably in their implementation details, while still being encompassed by the specification. Particular terminology used when describing certain features or aspects of various embodiments should not be taken to imply that the terminology is being redefined herein to be restricted to any specific characteristics, features, or aspects of the technology with which that terminology is associated. In general, the terms used in the following claims should not be construed to limit the technology to the specific embodiments disclosed in the specification, unless those terms are explicitly defined herein. Accordingly, the actual scope of the technology encompasses not only the disclosed embodiments, but also all equivalent ways of practicing or implementing the embodiments.

The language used in the specification has been principally selected for readability and instructional purposes. It may not have been selected to delineate or circumscribe the subject matter. It is therefore intended that the scope of the technology be limited not by this Detailed Description, but rather by any claims that issue on an application based hereon. Accordingly, the disclosure of various embodiments is intended to be illustrative, but not limiting, of the scope of the technology as set forth in the following claims.

What is claimed is:

1. A method performed by a computer program executing on a computing device, the method comprising:
receiving input that is indicative of a selection, by a user, of a data science project that utilizes a machine learning model trained to perform a task;
configuring an applied prototype that serves as a repository that includes code and information, if any, that is needed to programmatically produce another instance of the data science project in such a manner that the machine learning model is extendable to a different user or a different dataset; and
adding the applied prototype to a catalog by populating the repository into a data structure that corresponds to the catalog, so as to make the applied prototype accessible to another user for implementation as part of another data science project.

2. The method of claim 1, wherein the repository is one of multiple repositories stored in the data structure, and wherein each of the multiple repositories is representative of a different one of multiple applied prototypes.

3. The method of claim 2, further comprising:
receiving second input that is indicative of a selection, by a second user, of the applied prototype from among the multiple applied prototypes; and
receiving third input that is indicative of a selection, by the second user, of data to be used in combination with the applied prototype; and
deploying the applied prototype in the form of a new data science project in which the data is provided to the machine learning model as input.

4. The method of claim 3, wherein said deploying comprises:
constructing the new data science project based on the code and the information, if any, that is included in the repository corresponding to the applied prototype.

5. The method of claim 3, wherein the computer program adjusts the new data science project on behalf of the second user, as necessary, to accommodate the data.

6. The method of claim 2, wherein each of the multiple applied prototypes is accompanied by a metadata file that defines an operational characteristic of the corresponding applied prototype.

7. The method of claim 6, wherein the operational characteristic is (i) computing resources needed by the corresponding applied prototype or (ii) setup steps for installing the corresponding applied prototype.

8. The method of claim 1, wherein in the applied prototype, the machine learning model is served as a representational state transfer (REST) endpoint with automated lineage building to allow for dynamic reconfiguration.

9. The method of claim 1, wherein the applied prototype is only available to other users that are part of a same organization as the user.

10. The method of claim 1, further comprising:
receiving second input that is indicative of an approval, by an administrator, of the data science project;
wherein said configuring is performed in response to receiving the second input.

11. The method of claim 10, wherein the administrator is associated with an organization that operates the computer program and maintains the data structure that corresponds to the catalog.

12. A non-transitory medium with instructions stored thereon that, when executed by a processor of a computing device, cause the computing device to perform operations comprising:
receiving input that is indicative of a selection, by a user, of an applied prototype that serves as a repository for code corresponding to a data science project that utilizes a machine learning model trained to perform a task;
creating, in response to said receiving, a copy of the repository that corresponds to the applied prototype;
examining a metadata file that is maintained in the repository; and
initiating automatic execution of one or more steps specified in the metadata file to recreate the data science project in such a manner that the machine learning model is appliable to user-specific data.

13. The non-transitory medium of claim 12, wherein the metadata file includes information regarding a parameter of the applied prototype.

14. The non-transitory medium of claim 13, wherein the parameter pertains to an environment variable, a software-implemented engine responsible for executing the code, or a runtime environment.

15. The non-transitory medium of claim 13, wherein the one or more steps include:
causing digital presentation of the information regarding the parameter of the applied prototype on an interface,
in response to receiving second input that is indicative of a confirmation, by the user, of the information regarding the parameter,
constructing a new instance of the data science project using assets included in the copy of the repository.

16. The non-transitory medium of claim 15, wherein the assets include the code and information that is needed to programmatically recreate the new instance of the data science project.

17. The non-transitory medium of claim 15, wherein the one or more steps further include:
determining whether alteration of the machine learning model is necessary for the new instance of the data science project to be suitable for analysis of the user-specific data, and
in response to a determination that an alteration of the machine learning model is necessary,
implementing the alteration on behalf of the user.

18. The non-transitory medium of claim 15, wherein the one or more steps further include:
causing digital presentation of an indicium that visually illustrates progression as the new instance of the data science project is being constructed.

19. A method performed by a computer program executing on a computing device, the method comprising:
receiving first input that is indicative of a selection, by a user, of multiple applied prototypes from amongst a collection of applied prototypes,
wherein each of the multiple applied prototypes serves as a repository that includes code that is needed to programmatically produce another instance of a corresponding data science project that utilizes a machine learning model trained to perform a task;
receiving second input that is indicative of a request, from the user, to create a human-readable configuration file that identifies the multiple applied prototypes;
creating the human-readable configuration file in a data-serialization language;
populating, in the human-readable configuration file, information related to each of the multiple applied prototypes; and
causing the human-readable configuration file to be stored on a computer server.

20. The method of claim 19, wherein the computer server is a private computer server.

21. The method of claim 19, wherein the computer server is a public computer server.

22. The method of claim 19, wherein said causing permits the human-readable configuration file to be accessed by other users who are members of a same group as the user.

23. The method of claim 22, wherein the user and the other users are employees of a same organization.

24. The method of claim 19, wherein the human-readable configuration file includes, for each of the multiple applied prototypes, a link to the corresponding repository.

25. The method of claim 19, further comprising:
receiving third input that is indicative of a selection, by a second user, of the multiple applied prototypes from amongst a collection of applied prototypes; and
forking the human-readable configuration file that is representative of an existing catalog, so as to create a new catalog that includes the multiple applied prototypes for the second user.
